(19) United States
(12) Patent Application Publication
(10) Pub. No.: US 2005/0204619 A1
(43) Pub. Date: Sep. 22, 2005

(54) Method of extracting rutin from buck wheat growed by hydroponics

(76) Inventors: Yoon Chang Park, Kyungki-do (KR); Tae Kwan Kim, Kyungki-do (KR); Mi Nyeong Lee, Kyungki-do (KR); Byeong Rok Kim, Kangwon-do (KR)

Correspondence Address: Robert E Krebs;Thelen Reid & Priest, P O Box 640640, San Jose, CA, 95164-0640, US

(21) Appl. No.: 10/513,075

(22) PCT Filed: Apr. 20, 2003
(86) PCT No.: PCT/KR03/00869

§ 371 Date: Oct. 29, 2004

(30) Foreign Application Priority Data
Apr. 30, 2002 (KR) 10-2002-0023718

(51) Int. Cl. A61K 35/78; A01H 3/00

(52) U.S. Cl. 47/58.1 R; 514/27; 536/8; 424/725

(57) ABSTRACT

A method for producing a rutin-containing extract from mature buckwheat using a water culture system is provided. The method includes germinating a buckwheat seed, growing the buckwheat seed into mature buckwheat which contains the greatest amount of rutin, and extracting the rutin-containing extract which has pure rutin in high content from the mature buckwheat.

### TECHNICAL FIELD

The present invention relates to a method for preparing a rutin-containing extract from buckwheat, and more particularly, to a method for preparing a rutin-containing extract which has pure rutin in high content using a water culture system, comprising germinating a buckwheat seed, growing the buckwheat seed into mature buckwheat which contains the greatest amount of rutin, and extracting the rutin-containing extract from the mature buckwheat.

### BACKGROUND ART

Buckwheat contains 12 to 15% protein, and particularly, a large amount of essential amino acids. Buckwheat also contains a relatively large amount of fat, minerals such as iron, phosphorus, copper, and zinc, and vitamins B1 and B2. In particular, it is known that buckwheat contains a considerable amount of rutin, which has been increasingly utilized in modern medical and pharmaceutical industries.

Rutin (C₂₇H₃₀O₁₆; 2-phenyl-3,5,7,3′,4′-pentahydroxy benzopyrone), also known as vitamin P, has proved to be helpful in preventing cerebral hemorrhage by increasing a resistance of blood vessel. In addition, it has been reported that rutin can be used in the treatment of vascular diseases due to its pharmaceutical effect capable of controlling excessive permeation of blood vessels. As recent reports have disclosed, rutin possesses a pharmaceutical effect on diabetes and cancers, thus, studies on rutin have been actively carried out.

Methods of extracting a rutin-containing extract from buckwheat, which has been known to contain a relatively high amount of rutin, are known in the art.

By way of example, Korean Patent Application Laid-Open Publication No. 1998-20507 discloses a method for producing processed foods made from buckwheat, using buckwheat juice, by itself or in a dried state, obtained by squeezing a buckwheat bud of 7-10 cm long. Although a buckwheat bud, which has grown to a length of 7-10 cm post-germination, is used as a raw food material in the above disclosure, there is no mention of a method for extracting rutin from the buckwheat bud. In particular, squeezing the buckwheat bud may increase the contents of other components except for rutin in the obtained buckwheat juice.

Korean Patent Application Laid-Open Publication No. 2000-15805 discloses a method for extracting natural rutin from buckwheat. In this method, because extraction is carried out using dried buckwheat of a whole plant, the ratio of the rutin content in an extract to that in the raw material is low and thus the extraction efficiency is not good.

Korean Patent Application Laid-Open Publication No. 1997-88 discloses a method for extracting rutin from buckwheat with a root length of 0.01-40 cm cultivated at a temperature of 0-40° C. According to this method, since the germination rate of a buckwheat seed is very low, the yield of a rutin extract is poor. In addition, since the above root length, i.e., 0.01-40 cm, does not contain the greatest amount of rutin, an optimal extract cannot be obtained.

### DISCLOSURE OF THE INVENTION

The present invention has been made in view of the above problems. It is an object of the present invention to provide a method for preparing a rutin-containing extract which has pure rutin in high content. For this, a condition of mature buckwheat which contains the greatest amount of rutin is first searched. Then, under the optimal condition found by the search, a buckwheat seed is cultivated using a water culture system capable of increasing the rutin productivity to the maximum. Finally, a rutin-containing extract is obtained from the water-cultured buckwheat.

According to an aspect of the present invention, there is provided a method for producing a rutin-containing extract using a water culture system, the method comprising: planting buckwheat seeds in a seedbed; germinating the buckwheat seeds in a dark cultivation room while spraying water at an interval of 2 to 5 hours; growing the germinated buckwheat seeds into mature buckwheat with a stem length of 10-15 cm while spraying water at an interval of 3 to 5 hours; and extracting the rutin-containing extract from the mature buckwheat by adding 5 to 10 parts by weight of an extract solvent to 1 part by weight of the mature buckwheat at a temperature range of 50-80° C. for 1 to 3 hours, wherein the extract solvent is selected from the group consisting of ethanol, acetic acid, and a mixture thereof.

According to specific embodiments of the present invention, the seedbed comprises a lower plate and an upper plate. The buckwheat seeds are planted in the lower plate and shells of the germinated buckwheat seeds are removed when the germinated buckwheat seeds pass through the upper plate of the seedbed.

The method may further comprise storing the buckwheat seeds at a temperature of 0 to 5° C. for 7 to 10 days, washing and sterilizing the buckwheat seeds, before the planting.

The germinating of the seeds may be carried out at a temperature of 22 to 40° C. and the growing of the germinated seeds may be carried out at a temperature of 22 to 32° C.

A temperature of the sprayed water during the germinating and the growing may be the same as the temperature of the seedbed and the relative humidity in the cultivation room during the germinating and the growing may be maintained at 60 to 70%.

The method may further comprise freeze-drying the mature buckwheat after the growing.

The extract solvent may be a 30 to 80% aqueous ethanol solution or a 3 to 15% aqueous acetic solution.

### BRIEF DESCRIPTION OF THE DRAWINGS

FIG. 1A is a perspective view of a seedbed for cultivating buckwheat seeds according to an embodiment of the present invention, wherein the components of the seedbed are in separated states;

FIG. 1B is a perspective view of a seedbed for cultivating buckwheat seeds according to an embodiment of the present invention, wherein the components of the seedbed are in combined states; and

FIG. 2 is a schematic perspective view of an extractor to be used in the method for producing a rutin-containing extract according to the present invention.

### BEST MODE FOR CARRYING OUT THE INVENTION

Hereinafter, the present invention will be described in more detail.

As used herein, the term, “mature buckwheat” indicates buckwheat obtained by growing a buckwheat bud, which is germinated from a buckwheat seed, for a period of time sufficient to accomplish a desired stem length. The term, “stem” of the mature buckwheat indicates a whole portion of the mature buckwheat grown from a buckwheat seed.

A method for producing a rutin-containing extract according to the present invention can be largely divided into two steps. A first step is to grow buckwheat seeds into mature buckwheat with a stem length of about 10 to 15 cm, a state which contains the greatest amount of rutin, using a water culture system. A second step is to extract rutin from the mature buckwheat with a solvent.

These steps will now be described in more detail.

1. Preparation of Mature Buckwheat from Buckwheat Seeds.

Buckwheat, Fagopyrum esculentum, harvested in autumn (Yanbian, China), was used as a buckwheat source.

The preparation of mature buckwheat is largely divided into two stages: germination and growth. Before the germination, pretreatment may be carried out.

With respect to the pretreatment, first, buckwheat seeds are stored at a low temperature of 0 to 5° C. for at least one week before water culturing. The low-temperature storing improves the germination rate and growth rate of the buckwheat seeds.

Next, the buckwheat seeds are washed with low-temperature water of 10 to 20° C., preferably 14 to 17° C. and sterilized using an ultrasonic sterilizer for 20 to 30 minutes to eliminate bacteria.

The pretreated buckwheat seeds are planted in a seedbed as closest to one pile as possible. If the buckwheat seeds are too thickly planted, the growth rate of the buckwheat seeds after the germination decreases.

The seedbed may be selected from those conventionally used for cultivating buckwheat seeds. However, it is preferable to use a multi-layered seedbed with a lower plate and an upper plate to remove the shells of the buckwheat seeds.

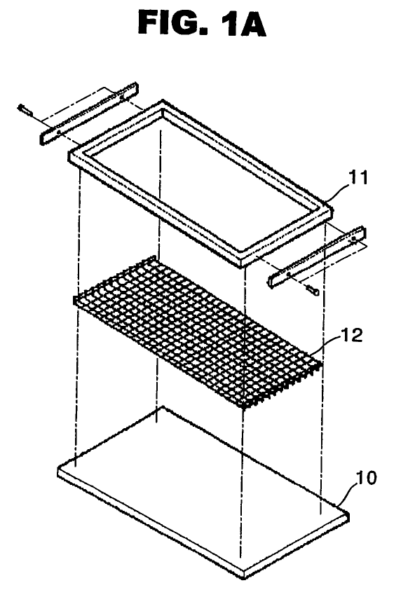

FIG. 1A is a perspective view of a seedbed for cultivating buckwheat seeds according to an embodiment of the present invention, wherein the components of the seedbed are in separated states and FIG. 1B is a perspective view of a seedbed for cultivating buckwheat seeds according to an embodiment of the present invention, wherein the components of the seedbed are in combined states.

Referring to FIGS. 1A and 1B, the multi-layered seedbed comprises a lower plate 10, a frame 11, and an upper plate 12. The lower plate 10 is installed in such a way that germinated buckwheat seeds are distributed to be of a thin and uniform thickness and drainage is facilitated. The frame 11 is located on the outer edge of the upper plate 12. The upper plate 12 is formed with a screen structure with a mesh size of 2.8 to 3.9 mm to remove the shells of the germinated buckwheat seeds during growth.

The upper plate 12 is coupled with the lower plate 10 in such a manner that the frame 11 is fixed on the lower plate 10 using several clamps 13.

Because the shells of the germinated buckwheat seeds are removed through the use of the seedbed during growth, additional step of shell removal after collecting the stems of mature buckwheat is not required.

After planting buckwheat seeds in a seedbed, the seedbed is placed in a dark cultivation room to induce the germination and growth of the buckwheat seeds. Also, it is preferable to sterilize the cultivation room using an ultraviolet lamp and a chlorine dioxide sprayer.

(1) Germination

Germination is carried out for about 30 to 60 hours, preferably 48 hours after the seedbed is placed in the dark cultivation room. After 48 hours of the germination, the size of the buds of the buckwheat seeds is in the range of about 0.5 to 1 cm and the temperature of the buckwheat seeds is in the range of about 27 to 32° C. The temperature of the cultivation room is maintained at about 22 to 40° C. because the germination rate decreases at a temperature outside the above range. Water is sprayed at a temperature of about 22 to 40° C., which is similar to the temperature of the cultivation room, at appropriate intervals, when the temperature of the buckwheat seeds exceeds 50° C. or when 2 to 5 hours elapses after the previous spray. During the germination, the humidity in the cultivation room is maintained at about 60-70%, preferably about 60%, using a humidity control system. Although the humidity is not a critical factor for the germination, if the humidity exceeds 70%, the buckwheat seeds are not germinated at an optimal state. Therefore, it is preferable to limit the humidity during the germination to the aforementioned range.

(2) Growth

Growth is carried out for about 100 to 140 hours, preferably about 130 hours post-germination. The growth is characterized by cultivating the germinated buckwheat seeds until the size of the stems of mature buckwheat is in the range of about 10 to 15 cm, preferably about 12 cm.

The temperature of the cultivation room is maintained at about 22 to 32° C. If the ambient temperature of the cultivation room is outside the above range, the growth rate of the germinated buckwheat seeds decreases. Water is sprayed at a temperature of about 22 to 32° C., which is similar to the temperature of the cultivation room, at appropriate intervals, when the temperature of the buckwheat seeds exceeds 32° C. or when 3 to 5 hours elapses after the previous spray. During the growth, the humidity in the cultivation room is maintained at about 60-70%, preferably about 60%, using a humidity control system. Although the humidity is not a critical factor for the growth, if the humidity exceeds 70%, the germinated buckwheat seeds are not grown at an optimal state. Therefore, it is preferable to limit the humidity during the growth to the aforementioned range.

2. Extraction of Rutin-Containing Extract from Mature Buckwheat

Among buckwheat cultivated according to section 1, while discarding buckwheat having brown roots, the remaining mature buckwheat with a stem size of about 10 to 15 cm is chosen for extraction of a rutin-containing extract. Preferably, sterilization and drying are carried out before the extraction.

The sterilization is carried out using an ultrasonic sterilizer and low-temperature water of 4 to 5° C. for 20 to 30 minutes. Low-temperature water is used to prevent further growth of mature buckwheat and to maintain the greatest amount of rutin in the mature buckwheat. The sterilization serves to remove bacteria from the mature buckwheat, which may have been contaminated by bacteria when handled by operators.

There are no particular limitations to the drying. However, it is preferable to use freeze drying or hot-air drying. Freeze drying is more preferable. In particular, during hot-air drying, it is preferable to maintain the drying temperature to 60° C. or less. Since rutin is easily destroyed by heat, an excessively high temperature may decrease the content of rutin.

After the sterilization and drying, a rutin-containing extract is extracted from the mature buckwheat in the following manner.

The extraction is carried out in such a manner that 5 to 10 parts by weight of an extract solvent is added to 1 part by weight of the mature buckwheat. A preferable extraction temperature ranges from 50 to 80° C., most preferably from 70 to 80° C. A preferable extraction time is 2 to 3 hours.

A buckwheat extract obtained according to the extraction of the present invention contains a higher amount of rutin, when compared to other buckwheat extracts.

3. Purification

The crude extract obtained in section 2 is purified.

Hereinafter, the present invention will be described more specifically by examples. However, the following examples are provided only for illustrations and thus the present invention is not limited to or by them.

### EXAMPLE 1

(1) Low-Temperature Storage of Buckwheat Seeds

Buckwheat seeds were stored at a low temperature of about 3° C. for at least 10 days before water culturing.

(2) Washing and Sterilization of Buckwheat Seeds

The buckwheat seeds were washed with water with a temperature of about 15° C. to remove impurities and sterilized with an ultrasonic sterilizer for 25 minutes to remove bacteria.

(3) Planting Buckwheat Seeds in Seedbed

The buckwheat seeds were planted on a seedbed as closest to one pile as possible using the weight of the buckwheat seeds.

(4) Placing Seedbed in Cultivation Room and Sterilization

The planted seedbed was placed in a dark cultivation room. Then, the cultivation room was sterilized using an ultraviolet sterilizer for one hour and then a chlorine dioxide sprayer for 10 minutes to remove bacteria in the cultivation room.

(5) Germination of Buckwheat Seeds

Germination was carried out while spraying water for about 48 hours after the seedbed was placed in the cultivation room.

During the germination, the temperature of the cultivation room was maintained at about 32° C. Water was sprayed at a temperature similar to the temperature of the cultivation room at an interval of about three hours. Humidity was maintained at about 60% using a humidity control system.

After the germination was carried out for 48 hours, the size of the buds of the germinated buckwheat seeds was 0.8 cm.

(6) Growth of Germinated Buckwheat Seeds

The germinated buckwheat seeds were water-cultured for about 130 hours into mature buckwheat.

During the growth, the temperature of the cultivation room was maintained at about 25° C. Water was sprayed at a temperature similar to the temperature of the cultivation room at an interval of about four hours. Humidity in the cultivation room was maintained at about 60%.

After the growth was carried out for 130 hours, the size of the stems of the mature buckwheat was about 13 cm.

(7) Sterilization of Mature Buckwheat

Among the above mature buckwheat, while discarding mature buckwheat having brown roots, the remaining mature buckwheat was sterilized using an ultrasonic sterilizer and low-temperature water of about 5° C. for about 30 minutes to remove bacteria.

(8) Drying Mature Buckwheat

The sterilized mature buckwheat was divided into three groups. That is, one group was freeze dried in such a manner that it was frozen at about −60° C. for two days and then thawed at about 35° C., another group was hot-air dried at about 45° C. for about 30 hours, and the third group was not subjected to drying.

(9) Rutin Extraction and Concentration System

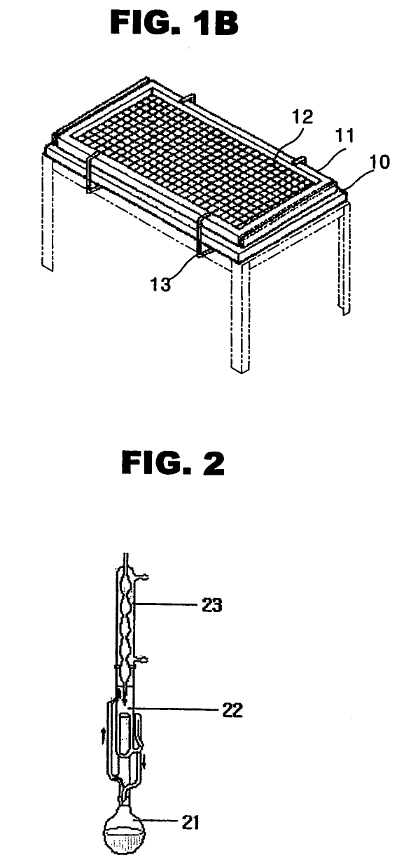

Rutin was extracted from the buckwheat samples obtained from section (8) using a soxhlet extractor as shown in FIG. 2. The soxhlet extractor comprises a solvent flask 21, a sample tube 22, and a cooler 23.

Extraction was carried out in the following manner:

100 g of an aliquot of each buckwheat sample in each group obtained from section (8) was placed in the sample tube 22, which was provided with a filter. 700 mL of water as an extraction solvent was injected into the flask 21, and then the extraction was carried out while heating water at about 75° C. under reflux in the cooler 23. Rutin extraction was carried out from the buckwheat samples in each group for 30 minutes, 60 minutes, 120 minutes, and 180 minutes, respectively, after a water temperature in the flask 21 reached about 75° C.

Due to floating substances, extracted samples were filtered using a filter with a large pore size to remove large-sized floating substances and then a filter with a pore size of about 0.3 μm to completely remove fine floating substances. Then, solvents were removed using a rotary vacuum evaporator.

The content of rutin in each extracted sample was determined using high performance liquid chromatography (HPLC) under the following conditions.
Detector: UV detector HPLC (BREEZE 1525 WORK STATION, WATERS)
Wavelength: 350 nm
Column: X-Terra
Mobile phase: solvent (acetic acid (2.4%)/ethanol/acetonitrile=35/5/10 (v/v/v)):methanol=70:30
Solvent flow rate: 1.0 ml/min
Sample volume: 5 μl

First, a rutin standard solution (rutin standards 100 ppm+100% methanol) was injected into HPLC to obtain a calibration curve. According to HPLC analytic results obtained using the standard solution, a residual time of rutin was about 6 minutes. By using the calibration curve according to the rutin content, the content of rutin contained in each sample solution was determined. The results are presented in Table 1 below.

### EXAMPLE 2

Rutin was extracted from buckwheat samples in the same manner as in Example 1 except that a 50% aqueous ethanol solution was used as an extraction solvent.

The content of rutin contained in the extracted samples was determined using HPLC and the results are presented in Table 1 below.

### EXAMPLE 3

Rutin was extracted from buckwheat samples in the same manner as in Example 1 except that a 100% aqueous ethanol solution was used as an extraction solvent.

The content of rutin contained in the extracted samples was determined using HPLC and the results are presented in Table 1 below.

TABLE 1

| Extraction | Time | Freeze drying | Hot-air drying | No drying¹⁾ |
|---|---|---|---|---|
| solvent | (min) | (mg/100 g) | (mg/100 g) | (mg/100 g) |
| Water | 30 | 600 | 150 | 240 |
| (Example 1) | 60 | 900 | 390 | 690 |
| | 120 | 1290 | 810 | 1230 |
| | 180 | 1980 | 990 | 1320 |
| 50% aqueous | 30 | 1350 | 270 | 330 |
| ethanol solution | 60 | 1650 | 480 | 570 |
| (Example 2) | 120 | 2250 | 960 | 1230 |
| | 180 | 2370 | 1140 | 1410 |
| 100% aqueous | 30 | 480 | 150 | 300 |
| ethanol solution | 60 | 810 | 390 | 600 |
| (Example 3) | 120 | 1080 | 630 | 1080 |
| | 180 | 1200 | 870 | 1230 |

¹⁾No drying: mature buckwheat not dried containing 95% of water.

As shown in Table 1, the content of rutin was greatest in the freeze-dried samples and the yield of rutin was greatest in the samples extracted using a 50% aqueous ethanol solution.

### EXAMPLE 4

Rutin was extracted from buckwheat samples in the same manner as in Example 1 except that a 10% aqueous acetic solution was used as an extraction solvent.

The content of rutin contained in the extracted samples was determined using HPLC and the results are presented in Table 2 below.

TABLE 2

| Extraction | | | | No |
|---|---|---|---|---|
| solvent | Time (min) | Freeze drying | Hot-air drying | drying |
| 10% aqueous | 30 | 540 | 210 | 840 |
| acetic solution | 60 | 900 | 540 | 1050 |
| (Example 4) | 120 | 1530 | 1080 | 1200 |
| | 180 | 2010 | 1050 | 1410 |

### EXAMPLE 5

The same experiments were carried out using other organs of buckwheat such as the flower and stem. As a result, it was demonstrated that a stem of 12 cm long contains the greatest amount of rutin.

### INDUSTRIAL APPLICABILITY

As apparent from the above description, a rutin-containing extract, which has pure rutin in high content, can be prepared according to the present invention.

1. A method for producing a rutin-containing extract using a water culture system, the method comprising:
planting buckwheat seeds in a seedbed;
germinating the buckwheat seeds in a dark cultivation room while spraying water at an interval of 2 to 5 hours;
growing the germinated buckwheat seeds into mature buckwheat with a stem length of 10-15 cm while spraying water at an interval of 3 to 5 hours; and
extracting the rutin-containing extract from the mature buckwheat by adding 5 to 10 parts by weight of an extract solvent to 1 part by weight of the mature buckwheat at a temperature range of 50-80° C. for 1 to 3 hours, wherein the extract solvent is selected from the group consisting of ethanol, acetic acid, and a mixture thereof.

2. The method according to claim 1, wherein the seedbed comprises a lower plate and an upper plate, the buckwheat seeds are planted in the lower plate, and shells of the germinated buckwheat seeds are removed when the germinated buckwheat seeds pass through the upper plate of the seedbed.

3. The method according to claim 1, further comprising storing the buckwheat seeds at a temperature of 0 to 5° C. for 7 to 10 days, before the planting.

4. The method according to claim 1, further comprising washing and sterilizing the buckwheat seeds, before the planting.

5. The method according to claim 1, wherein the germinating is carried out at a temperature of 22 to 40° C.

6. The method according to claim 1, wherein the growing is carried out at a temperature of 22 to 32° C.

7. The method according to claim 1, wherein a temperature of the sprayed water during the germinating and the growing is the same as the temperature of the seedbed.

8. The method according to claim 1, wherein a relative humidity in the cultivation room during the germinating and the growing is maintained at 60 to 70%.

9. The method according to claim 1, further comprising freeze-drying the mature buckwheat after the growing.

10. The method according to claim 1, wherein the extract solvent is a 30 to 80% aqueous ethanol solution or a 3 to 15% aqueous acetic solution.

11. The method according to claim 2, further comprising storing the buckwheat seeds at a temperature of 0 to 5° C. for 7 to 10 days, before the planting.

12. The method according to claim 2, further comprising washing and sterilizing the buckwheat seeds, before the planting.

13. The method according to claim 2, wherein the germinating is carried out at a temperature of 22 to 40° C.

14. The method according to claim 2, wherein the growing is carried out at a temperature of 22 to 32° C.

15. The method according to claim 2, wherein a temperature of the sprayed water during the germinating and the growing is the same as the temperature of the seedbed.

16. The method according to claim 2, wherein a relative humidity in the cultivation room during the germinating and the growing is maintained at 60 to 70%.

17. The method according to claim 2, further comprising freeze-drying the mature buckwheat after the growing.

18. The method according to claim 2, wherein the extract solvent is a 30 to 80% aqueous ethanol solution or a 3 to 15% aqueous acetic solution.
